(19) United States
(12) Patent Application Publication
(10) Pub. No.: US 2017/0271658 A1
(43) Pub. Date: Sep. 21, 2017

(54) CATHODE COMPOSITE MATERIAL, LITHIUM ION BATTERY, AND METHOD FOR MAKING THE SAME

(71) Applicants: JIANGSU HUADONG INSTITUTE OF LI-ION BATTERY CO., LTD., Suzhou (CN); TSINGHUA UNIVERSITY, Beijing (CN)

(72) Inventors: Guan-Nan Qian, Suzhou (CN); Xiang-Ming He, Beijing (CN); Li Wang, Beijing (CN); Yu-Ming Shang, Beijing (CN); Jian-Jun Li, Beijing (CN); Jing Luo, Suzhou (CN); Cheng-Hao Xu, Beijing (CN); Jian Gao, Beijing (CN); Yao-Wu Wang, Beijing (CN)

(73) Assignees: JIANGSU HUADONG INSTITUTE OF LI-ION BATTERY CO., LTD., Suzhou (CN); TSINGHUA UNIVERSITY, Beijing (CN)

(21) Appl. No.: 15/612,208

(22) Filed: Jun. 2, 2017

Related U.S. Application Data
(63) Continuation of application No. PCT/CN2015/096271, filed on Dec. 3, 2015.

(30) Foreign Application Priority Data
Dec. 5, 2014 (CN) 201410733774.5

(51) Int. Cl. H01M 4/36; H01M 4/60; H01M 4/505; H01M 4/525; H01M 10/0525; C08G 73/12

(52) U.S. Cl. CPC H01M 4/366; H01M 10/0525; H01M 4/364; C08G 73/121; H01M 4/505; H01M 4/525; H01M 4/60; C08K 5/00

(57) ABSTRACT

A method for making a cathode composite material is disclosed. In the method, a maleimide-based material is provided. The maleimide-based material is a maleimide monomer, a maleimide polymer formed from the maleimide monomer, or combinations thereof. The maleimide-based material, an inorganic electrical conductive carbonaceous material, and a cathode active material are mixed to form a mixture. The mixture is heated to a temperature of about 200° C. to about 280° C. in a protective gas to obtain the cathode composite material. A cathode composite material and a lithium ion battery are also disclosed.

### CROSS-REFERENCE TO RELATED APPLICATIONS

This application claims all benefits accruing under 35 U.S.C. §119 from China Patent Application No. 201410733774.5, filed on Dec. 5, 2014 in the State Intellectual Property Office of China, the content of which is hereby incorporated by reference. This application is a continuation under 35 U.S.C. §120 of international patent application PCT/CN2015/096271 filed on Dec. 3, 2015, the content of which is also hereby incorporated by reference.

### FIELD

The present disclosure relates to cathode composite materials and method for making the same, and lithium ion batteries using the cathode composite materials and methods for making the same.

### BACKGROUND

With the rapid development of portable electronic products, electric vehicles, and energy storage systems, there is an increasing need for lithium ion batteries due to their excellent performance and characteristics such as high energy density, long cyclic life, no memory effect, and light pollution when compared with conventional rechargeable batteries. An oligomer with a relatively small average molecular weight formed from a polymerization between maleimide and barbituric acid at a relatively low temperature (e.g., 130° C.) can be used as a protective film covered on an electrode active material to block an ionic conduction to inhibit thermal runaway.

### SUMMARY

One aspect of the present disclosure is to provide a cathode composite material, a method for making the same, a lithium ion battery using the cathode composite material, and a method for making the lithium ion battery.

A method for making a cathode composite material comprises: providing a maleimide-based material and an inorganic electrical conductive carbonaceous material, the maleimide-based material is selected from one or more of maleimide monomers and maleimide polymers formed from the maleimide monomers; mixing uniformly the maleimide-based material, the inorganic electrical conductive carbonaceous material, and a cathode active material to form a mixture; and heating the mixture to a temperature of about 200° C. to about 280° C. in a protective gas to obtain the cathode composite material.

A cathode composite material comprises a cathode active material and an inorganic-organic composite material composited with the cathode active material, wherein the inorganic-organic composite material comprises an inorganic electrical conductive carbonaceous material and a crosslinked polymer. The crosslinked polymer is formed by heating a maleimide-based material to a temperature of about 200° C. to about 280° C. in the protective gas.

A method for making a lithium ion battery comprises: obtaining the cathode composite material by the above-mentioned method; coating the cathode composite material on a surface of a cathode current collector to form a cathode; and assembling the cathode with an anode, a separator, and an electrolyte solution to form the lithium ion battery.

A lithium ion battery comprises a cathode, an anode, a separator, and an electrolyte solution. The cathode comprises the above-mentioned cathode composite material.

The present disclosure overcomes a technical bias in prior art, heating the mixture of the maleimide-based material as an organic phase, the inorganic electrical conductive carbonaceous material as an inorganic phase, and a cathode active material at a relatively high temperature to perform a crosslinking reaction, thereby producing the inorganic-organic composite material on the surface of the cathode active material. The organic phase is formed into a high molecular weight polymer. The inorganic-organic composite material can improve an electrode stability and thermal stability of the lithium ion battery, play a role of overcharge protection, and achieve a relatively better rating performance of the lithium ion battery.

### BRIEF DESCRIPTION OF THE DRAWINGS

Implementations are described by way of example only with reference to the attached figures.

FIG. 1 is a graph showing AC impedances of Examples and Comparative Examples of the lithium ion batteries.

FIG. 2 is a graph showing cycling performances of Examples and Comparative Examples the lithium ion batteries.

FIG. 3 is a graph showing rating performances of Examples and Comparative Examples of the lithium ion batteries.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

The cathode composite material, the method for making the same, the lithium ion battery using the cathode composite material, and the method for making the lithium ion battery provided by the present disclosure are described in details with reference to the accompanying drawings and specific examples. Also, the description is not to be considered as limiting the scope of the embodiments described herein.

In one embodiment, a method for making a cathode composite material comprising steps of:
S1, providing a maleimide-based material and an inorganic electrical conductive carbonaceous material, the maleimide-based material is selected from one or more of maleimide monomers and maleimide polymers formed from the maleimide monomers;
S2, mixing uniformly the maleimide-based material, the inorganic electrical conductive carbonaceous material, and a cathode active material to form a mixture; and
S3, heating the mixture to a temperature of about 200° C. to about 280° C. in a protective gas to obtain the cathode composite material.

The inorganic electrical conductive carbonaceous material can be one or more of acetylene black, carbon black, carbon nanotubes, and graphene. The inorganic electrical conductive carbonaceous material can be nanosized, having a particle size of about 0.1 nm to about 100 nm.

The maleimide monomer comprises at least one of a monomaleimide monomer, a bismaleimide monomer, a polymaleimide monomer, and a maleimide derivative monomer.

The monomaleimide monomer can be represented by a general formula I below.

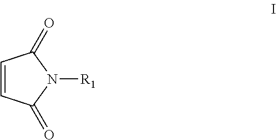

In the formula I, R₁ is a monovalent organic substituent. More specifically, R₁ can be —R, —RNH₂R, —C(O)CH₃, —CH₂OCH₃, —CH₂S(O)CH₃, a monovalent alicyclic group, a monovalent substituted aromatic group, or a monovalent unsubstituted aromatic group, such as —C₆H₅, —C₆H₄C₆H₅, or —CH₂(C₆H₄)CH₃. R can be a hydrocarbyl with 1 to 6 carbon atoms, such as an alkyl with 1 to 6 carbon atoms. In the monovalent substituted aromatic group, an atom, such as hydrogen, can be substituted by a halogen, an alkyl with 1 to 6 carbon atoms, or a silane group with 1 to 6 carbon atoms to form the monovalent substituted aromatic group. The monovalent unsubstituted aromatic group can be phenyl, methyl phenyl, or dimethyl phenyl. A number of benzene rings in the monovalent substituted aromatic group or the monovalent unsubstituted aromatic group can be 1 to 2.

The maleimide monomer can be selected from N-phenyl-maleimide, N-(p-tolyl)-maleimide, N-(m-tolyl)-maleimide, N-(o-tolyl)-maleimide, N-cyclohexyl-maleimide, monomaleimide, maleimidephenol, maleimidebenzocyclobutene, dimethylphenyl-maleimide, N-methyl-maleimide, ethenyl-maleimide, thio-maleimide, ketone-maleimide, methylene-maleimide, maleimide-methyl-ether, maleimide-ethanediol, 4-maleimide-phenyl sulfone, and combinations thereof.

The bismaleimide monomer can be represented by formulas II or III:

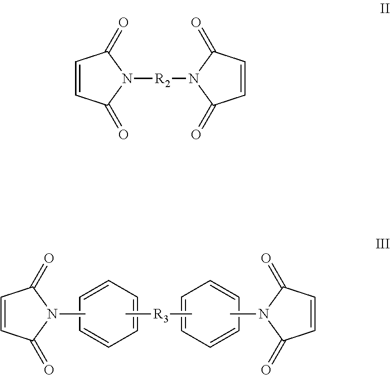

In formula II, R₂ is a bivalent organic substituent. More specifically, R₂ can be —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —R—Si(CH₃)₂—O—Si(CH₃)₂—R—, a bivalent alicyclic group, a bivalent substituted aromatic group, or a bivalent unsubstituted aromatic group, such as phenylene (—C₆H₄—), diphenylene (—C₆H₄C₆H₄—), substituted phenylene, substituted diphenylene, —(C₆H₄)—R₃—(C₆H₄)—, —CH₂(C₆H₄)CH₂—, or —CH₂(C₆H₄)(O)—. In formula III, R₃ can be —CH₂—, —C(O)—, —C(CH₃)₂—, —O—, —O—O—, —S—, —S—S—, —S(O)—, or —(O)S(O)—. R can be a hydrocarbyl with 1 to 6 carbon atoms, such as an alkyl with 1 to 6 carbon atoms. An atom, such as hydrogen, of the bivalent aromatic group can be substituted by a halogen, an alkyl with 1 to 6 carbon atoms, or a silane group with 1 to 6 carbon atoms to form the bivalent substituted aromatic group. A number of benzene rings in the bivalent substituted aromatic group or the bivalent unsubstituted aromatic group can be 1 to 2.

The bismaleimide monomer can be selected from N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-thiodimaleimide, N,N′-dithiodimaleimide, N,N′-ketonedimaleimide, N,N′-methylene-bismaleimide, bismaleimidomethyl-ether, 1,2-bismaleimido-1,2-ethandiol, N,N′-4,4′-diphenyl-ether-bismaleimide, 4,4′-bismaleimido-diphenylsulfone, and combinations thereof.

The maleimide derivative monomer can be obtained by substituting a hydrogen atom of the monomaleimide monomer, the bismaleimide monomer, or the multimaleimide monomer with a halogen atom.

In S1, the maleimide polymer can be formed by dissolving and mixing a barbituric acid compound and the maleimide monomer in an organic solvent to form a solution; and heating and stirring the solution at a temperature of about 100° C. to about 150° C. to form the maleimide polymer.

A molar ratio of the barbituric acid compound to the maleimide monomer can be about 1:1 to about 1:20, such as about 1:3 to about 1:10. The organic solvent can be one or more of N-methyl pyrrolidone (NMP), gamma-butyrolactone, propylene carbonate, dimethyl formamide, and dimethyl acetamide. In one embodiment, the solution can be heated at about 130° C. The stirring time can be decided by the amount of the solution, such as from about 1 hour to about 72 hours.

The barbituric acid compound can be barbituric acid or derivatives of the barbituric acid, represented by the following general formulas IV, V, VI, or VII:

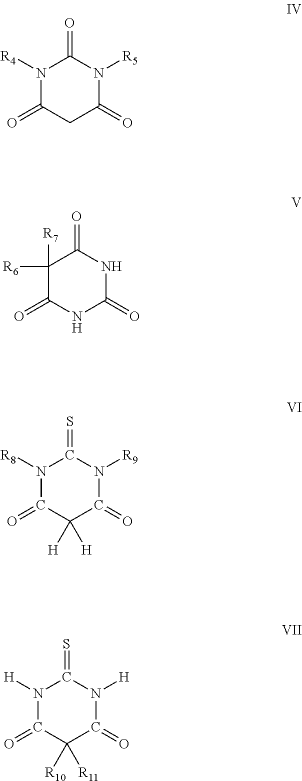

wherein R₄, R₅, R₆, R₇, R₈, R₉, R₁₀, and R₁₁ can be the same or different substituted groups, such as H, CH₃, C₂H₅, C₆H₅, CH(CH₃)₂, CH₂CH(CH₃)₂, CH₂CH₂CH(CH₃)₂, or

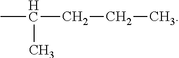

When R₄, R₅, R₆, R₇, is H, the formulas IV and V are the barbituric acid.

The maleimide polymer can be a low-molecular weight polymer having an average molecular weight in a range from about 200 to about 2999.

In S2, a mass ratio of the inorganic electrical conductive carbonaceous material to the maleimide-based material can be in a range from about 1:10 to about 1:1. A ratio of a total mass of the inorganic electrical conductive carbonaceous material and the maleimide-based material to a mass of the cathode active material can be in a range from about 1:9999 to about 5:95.

In one embodiment of S2, the maleimide-based material can be firstly dispersed in an organic solvent, such as forming a solution having the maleimide-based material dissolved therein, and then the inorganic electrical conductive carbonaceous material and the cathode active material can be added to the solution, accompanied by stirring or ultrasonic vibrating at room temperature to uniformly mix the materials. The solution having the maleimide-based material dissolved therein can have a relatively large amount. A mass ratio of the solution to a sum of the inorganic electrical conductive carbonaceous material and the cathode active material can be in a range from about 1:1 to about 1:10, such as 1:1 to 1:4. A mass percentage of the maleimide-based material in the solution can be in a range from about 1% to about 5%.

In another embodiment of S2, the maleimide-based material, the inorganic electrical conductive carbonaceous material, and the cathode active material can be mixed simultaneously in the organic solvent. By strictly repressing the amount of the organic solvent, a solid-solid mixing among the maleimide-based material, the inorganic electrical conductive carbonaceous material, and the cathode active material can be achieved, accompanied by solid state mixing steps such as a ball-milling step to achieve the uniform mixture. A mass percentage of the organic solvent used in the mixing can be in a range from about 0.01% to about 10%.

The mixture can be dried (e.g., at about 50° C. to about 80° C.) to remove all the organic solvent therein. The organic solvent can be one or more of gamma-butyrolactone, propylene carbonate, and NMP.

In yet another embodiment, the maleimide monomer, the inorganic electrical conductive carbonaceous material, and the cathode active material can be firstly mixed in the organic solvent, and then added with the barbituric acid compound, stirred at about 100° C. to about 150° C. to form the maleimide polymer directly on the surface of the cathode active material.

In S3, when the maleimide-based material comprises the maleimide monomer, the heating to the temperature of about 200° C. to about 280° C. in the protective gas can directly polymerize the maleimide monomer into a high-molecular weight crosslinked polymer. When the maleimide-based material comprises the low-molecular weight polymer, the heating to the temperature of about 200° C. to about 280° C. in the protective gas can crosslink the low-molecular weight polymer into the high-molecular weight crosslinked polymer. The low-molecular weight polymer formed at the temperature of about 100° C. to about 150° C. is capable of being dissolved in the organic solvent. The high-molecular weight crosslinked polymer formed at the temperature of about 200° C. to about 280° C. is completely insoluble to the organic solvent. An average molecular weight of the high-molecular weight crosslinked polymer can be in a range from about 5000 to about 50000.

By mixing the maleimide-based material, the inorganic electrical conductive carbonaceous material, and the cathode active material, an inorganic-organic composite coating layer can be formed on the surface of the cathode active material. The heating at the temperature of about 200° C. to about 280° C. can form a mixture of the crosslinked polymer and the inorganic electrical conductive carbonaceous material uniformly coating the surface of the cathode active material to form a core-shell structure. The protective gas can be a nitrogen gas or an inert gas. During the heating, the inorganic electrical conductive carbonaceous material is stable and does not participate the chemical reaction with the maleimide-based material.

In one embodiment, S3 can be heating the mixture to the temperature of about 200° C. to about 280° C. and then decreased to a lower temperature of about 160° C. to about 190° C. in the protective gas to obtain the cathode composite material. The heating at the lower temperature can uniformly solidify the crosslinked polymer to form a uniform coating layer on the cathode active material.

One embodiment of the cathode composite material comprises the cathode active material and an inorganic-organic composite material composited with the cathode active material. The inorganic-organic composite material comprises the inorganic electrical conductive carbonaceous material and the crosslinked polymer. The inorganic electrical conductive carbonaceous material is uniformly distributed in the crosslinked polymer. The crosslinked polymer is formed by heating the maleimide-based material to the temperature of about 200° C. to about 280° C. in the protective gas. The inorganic-organic composite material can be uniformly mixed with the cathode active material, or can be coated on the surface of the cathode active material to form the core-shell structure. A thickness of the coating layer of the inorganic-organic composite material on the cathode active material can be in a range from about 5 nm to about 100 nm, such as smaller than 30 nm. A mass percentage of the inorganic-organic composite material in the cathode composite material can be in a range from about 0.01% to about 10%, and can be about 0.1% to about 5% in one embodiment, or about 1% to about 2% in another embodiment. In the inorganic-organic composite material, a mass ratio of the inorganic electrical conductive carbonaceous material to the crosslinked polymer can be in a range from about 1:10 to about 1:1.

The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide.

The cathode composite material can further comprise a conducting agent and/or a binder. The conducting agent can be carbonaceous materials, such as at least one of carbon black, conducting polymers, acetylene black, carbon fibers, carbon nanotubes, and graphite. The binder can comprise at least one of polyvinylidene fluoride (PVDF), polyvinylidene fluoride, polytetrafluoroethylene (PTFE), fluoro rubber, ethylene propylene diene monomer, and styrene-butadiene rubber (SBR).

One embodiment of a method for making a lithium ion battery is also disclosed, and the method comprises:
obtaining the cathode composite material by the above-mentioned method;
coating the cathode composite material on a surface of a cathode current collector to form a cathode; and
assembling the cathode with an anode, a separator, and an electrolyte solution to form the lithium ion battery.

One embodiment of the lithium ion battery comprises the cathode, the anode, the separator, and the electrolyte solution. The cathode is separated from the anode by the separator. The cathode can further comprise the cathode current collector and the cathode composite material coated on the surface of the cathode current collector. The anode can further comprise an anode current collector and an anode material coated on the anode current collector. The cathode composite material and the anode material are faced to each other and separated from each other by the separator.

The anode material can comprise an anode active material, a conducting agent, and a binder, which are uniformly mixed with each other. The anode active material can comprise at least one of lithium titanate, graphite, mesophase carbon micro beads (MCMB), acetylene black, mesocarbon miocrobead, carbon fibers, carbon nanotubes, and cracked carbon. The conducting agent can comprise carbonaceous materials, such as at least one of carbon black, conducting polymers, acetylene black, carbon fibers, carbon nanotubes, and graphite. The binder can comprise at least one of polyvinylidene fluoride (PVDF), polyvinylidene fluoride, polytetrafluoroethylene (PTFE), fluoro rubber, ethylene propylene diene monomer, and styrene-butadiene rubber (SBR).

The separator can be polyolefin microporous membrane, modified polypropylene fabric, polyethylene fabric, glass fiber fabric, superfine glass fiber paper, vinylon fabric, or composite membrane of nylon fabric, and wettable polyolefin microporous membrane composited by welding or bonding.

The electrolyte liquid comprises a lithium salt and a non-aqueous solvent. The non-aqueous solvent can comprise at least one of cyclic carbonates, chain carbonates, cyclic ethers, chain ethers, nitriles, amides and combinations thereof, such as ethylene carbonate (EC), diethyl carbonate (DEC), propylene carbonate (PC), dimethyl carbonate (DMC), ethyl methyl carbonate (EMC), butylene carbonate, gamma-butyrolactone, gamma-valerolactone, dipropyl carbonate, N-methyl pyrrolidone (NMP), N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, and 1,2-dimethoxyethane.

The lithium salt can comprise at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

### Example 1

N-phenyl-maleimide and barbituric acid are mixed in a molar ratio of about 2:1 and dissolved in NMP. The mixed reactants are stirred and heated at about 130° C. for about 24 hours. The product is cooled and precipitated in ethanol. The precipitate is washed and dried to obtain polymer I.

1 g of the polymer I, 1 g of the acetylene black, and 98 g of the LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product I containing 2% of the inorganic-organic composite coating layer is obtained and cooled to room temperature.

### Example 2

Polymer I is formed by the same method as in Example 1. 1 g of the polymer I, 1 g of the carbon nanotubes, and 98 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product II containing 2% of the inorganic-organic composite coating layer is obtained and cooled to room temperature.

### Example 3

Polymer I is formed by the same method as in Example 1. 1 g of the polymer I, 1 g of the conductive carbon black, and 98 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product III containing 2% of the inorganic-organic composite coating layer is obtained and cooled to room temperature.

### Example 4

Polymer I is formed by the same method as in Example 1. 1 g of the polymer I, 1 g of the carbon black type conducting agent (super P), and 98 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product IV containing 2% of the inorganic-organic composite coating layer is obtained and cooled to room temperature.

### Example 5

Polymer I is formed by the same method as in Example 1. 1 g of the polymer I, 1 g of the graphene, and 98 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product V containing 2% of the inorganic-organic composite coating layer is obtained and cooled to room temperature.

### Example 6

Polymer I is formed by the same method as in Example 1. 0.5 g of the polymer I, 0.5 g of the acetylene black, and 99 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product VI containing 1% of the inorganic-organic composite coating layer is obtained and cooled to room temperature.

### Example 7

Polymer I is formed by the same method as in Example 1. 2 g of the polymer I, 2 g of the acetylene black, and 96 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product VII containing 4% of the inorganic-organic composite coating layer is obtained and cooled to room temperature.

### Example 8

Polymer I is formed by the same method as in Example 1. 3 g of the polymer I, 3 g of the acetylene black, and 94 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product VIII containing 6% of the inorganic-organic composite coating layer is obtained and cooled to room temperature.

### Example 9

Polymer I is formed by the same method as in Example 1. 5 g of the polymer I, 5 g of the acetylene black, and 90 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of about 5° C./min, stayed at about 240° C. for about 1 hour. Then the temperature is decreased to about 180° C. where the mixture is stayed for about 1 hour, and a product IX containing 10% of the inorganic-organic composite coating layer is obtained and cooled to room temperature.

### Example 10

Bismaleimide and barbituric acid are mixed in a molar ratio of about 2:1 and dissolved in NMP. The mixed reactants are stirred and heated at about 130° C. for about 24 hours. The product is cooled and precipitated in ethanol. The precipitate is washed and dried to obtain polymer II.

1 g of the polymer II, 1 g of the acetylene black, and 98 g of the LiNi_{1/3}Co_{1/3}Mn_{1/3}O₂ are mixed together. A small amount of NMP is added to the mixture to dissolve the polymer II, and the mixture is milled for about 2 hours, then dried at about 70° C. The dried mixture is heated in an oven filled with nitrogen gas to about 260° C. at a speed of about 5° C./min, stayed at about 260° C. for about 1 hour. Then the temperature is decreased to about 180° C. where the mixture is stayed for about 1 hour, and a product X containing 2% of the inorganic-organic composite coating layer is obtained and cooled to room temperature.

### Example 11

Bismaleimide represented by a formula VIII as shown below and barbituric acid are mixed in a molar ratio of about 2:1 and dissolved in NMP. The mixed reactants are stirred and heated at about 130° C. for about 24 hours. The product is cooled and precipitated in ethanol. The precipitate is washed and dried to obtain polymer III.

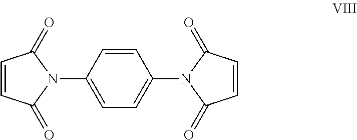 [SMILES: O=C1C=CC(=O)N1c1ccc(N2C(=O)C=CC2=O)cc1]

1 g of the polymer III, 1 g of the acetylene black, and 98 g of the LiNi_{1/3}Co_{1/3}Mn_{1/3}O₂ are mixed together. A small amount of NMP is added to the mixture to dissolve the polymer II. The mixture is milled for about 2 hours, then dried at about 70° C. The dried mixture is heated in an oven filled with nitrogen gas to about 280° C. at a speed of about 5° C./min, stayed at about 280° C. for about 1 hour. Then the temperature is decreased to about 180° C. where the mixture is stayed for about 1 hour, and a product XI containing 2% of the inorganic-organic composite coating layer is obtained and cooled to room temperature.

### Example 12

80% of the product I, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 13

80% of the product II, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 14

80% of the product III, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 15

80% of the product IV, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 16

80% of the product V, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 17

80% of the product VI, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode electrode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 18

80% of the product VII, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 19

80% of the product VIII, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 20

80% of the product IX, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Example 21

80% of the product I, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode.

94% of anode graphite, 3.5% of the PVDF, and 2.5% of the conducting graphite by mass percent are mixed and dispersed by the NMP to form a slurry. The slurry is coated on a copper foil and vacuum dried at about 100° C. to obtain the anode electrode.

The cathode and the anode are assembled and rolled up to form a 63.5 mm×51.5 mm×4.0 mm sized soft packaged battery. The electrolyte liquid is 1 M of LiPF₆ dissolved in a solvent mixture of EC/DEC/EMC=1/1/1(v/v/v).

### Example 22

80% of the product X, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode.

80% of anode graphite, 10% of the PVDF, and 10% of the conducting graphite by mass percent are mixed and dispersed by the NMP to form a slurry. The slurry is coated on a copper foil and vacuum dried at about 100° C. to obtain the anode electrode.

The cathode and the anode are assembled and rolled up to form a 63.5 mm×51.5 mm×4.0 mm sized soft packaged battery. The electrolyte liquid is 1 M of LiPF₆ dissolved in a solvent mixture of EC/DEC/EMC=1/1/1(v/v/v).

### Example 23

80% of the product XI, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode.

80% of anode graphite, 10% of PVDF, and 10% of the conducting graphite by mass percent are mixed and dispersed by the NMP to form a slurry. The slurry is coated on a copper foil and vacuum dried at about 100° C. to obtain the anode electrode.

The cathode and the anode are assembled and rolled up to form a 63.5 mm×51.5 mm×4.0 mm sized soft packaged battery. The electrolyte liquid is 1 M of LiPF₆ dissolved in a solvent mixture of EC/DEC/EMC=1/1/1(v/v/v).

### Comparative Example 1

Polymer I is formed by the same method as in Example 1. 1 g of the polymer I and 99 g of LiNi_{1/3}Co_{1/3}Mn_{1/3}O₂ are mixed together. A small amount of NMP is added to the mixture to dissolve the polymer I, and the mixture is milled for about 2 hours, then dried at about 70° C. The dried mixture is heated in an oven filled with nitrogen gas to about 240° C. at a speed of 5° C./min, stayed at 240° C. for about 1 hour. Then the temperature is decreased to about 180° C. where the mixture is stayed for about 1 hour, and a comparative product is obtained and cooled to room temperature.

### Comparative Example 2

80% of LiNi_{1/3}Co_{1/3}Mn_{1/3}O₂, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Comparative Example 3

80% of the comparative product, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode. The counter electrode is lithium metal. The electrolyte liquid is 1 M of LiPF₆ dissolved in a solvent mixture of EC/DEC/EMC=1/1/1(v/v/v). A 2032 button battery is assembled, and a charge-discharge performance is tested.

### Comparative Example 4

80% of LiNi_{1/3}Co_{1/3}Mn_{1/3}O₂, 10% of the PVDF, and 10% of the conducting graphite by mass percent are mixed and dispersed by the NMP to form a slurry. The slurry is coated on an aluminum foil and vacuum dried at about 120° C. for about 12 hours to obtain the cathode.

80% of anode graphite, 10% of PVDF, and 10% of the conducting graphite by mass percent are mixed and dispersed by the NMP to form a slurry. The slurry is coated on a copper foil and vacuum dried at about 100° C. to obtain the anode.

The cathode and the anode are assembled and rolled up to form a 63.5 mm×51.5 mm×4.0 mm sized soft packaged battery. The electrolyte liquid is 1 M of LiPF₆ dissolved in a solvent mixture of EC/DEC/EMC=1/1/1(v/v/v).

Referring to Table 1, the batteries of Examples 21 to 23 and Comparative Example 4 are overcharged to 10V at a current rate of IC to observe the phenomenon. The highest temperature during the overcharge process of the batteries in Examples 21 to 23 is about 93° C. and the batteries does not show any obvious deformation. The battery of Comparative Example 4 burns when it is overcharge to about 8V, and the temperature of the battery rises rapidly above 480° C.

TABLE 1
Overcharge Test Results of Full Cells

| | Highest temperature | |
|---|---|---|
| | (° C.) | Overcharge phenomenon |
| Example 21 | 93 | No combustion, no explosion |
| Example 22 | 85 | No combustion, no explosion |
| Example 23 | 82 | No combustion, no explosion |
| Comparative | 480 | Burning |
| Example 4 | | |

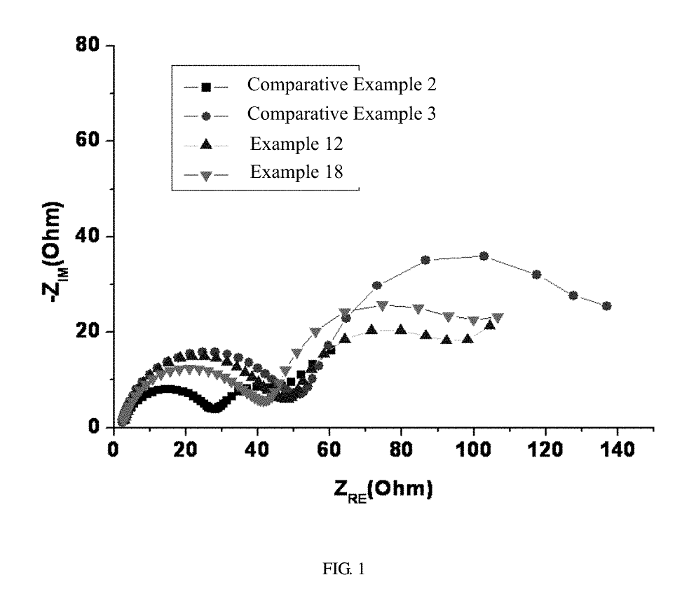

The batteries in Examples 12, 18 and Comparative Examples 2, 3 are charged to 4.6 V to be full state. The batteries are subjected to an AC impedance test with a frequency range of 100 mHz to 100 kHz and an amplitude of 5 mV. Referring to FIG. 1, after the first cycle, the battery in Comparative Example 2 has the smallest impedance, and the battery in Comparative Example 3 has the largest impedance. By adding the inorganic electrical conductive carbonaceous material, the impedance is obviously decreased compared to Comparative Example 3.

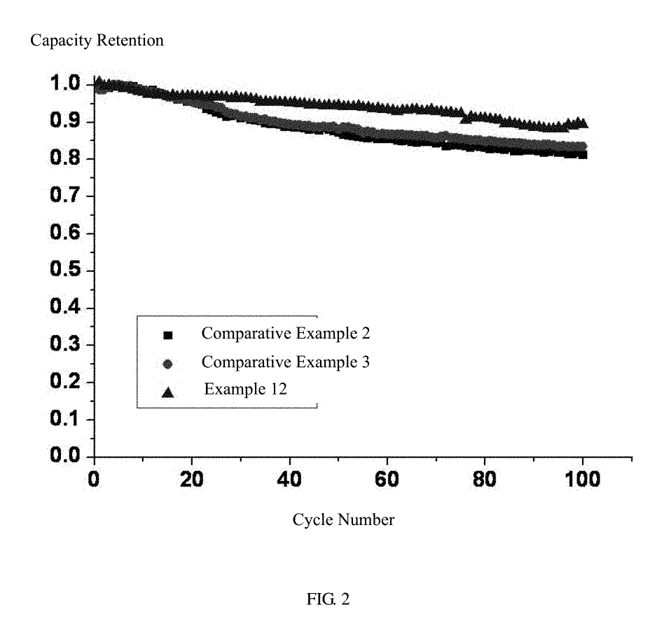

Referring to FIG. 2 and Table 2, the batteries in Examples 12, 13, 16, 17, 18 and Comparative Examples 2, 3 are charged and discharged at a constant current rate (C-rate) of 0.2C in a voltage range from 2.8V to 4.6V. The capacity retention of Example 12 is the highest and the capacity retention of Comparative Example 3 is higher than that of Comparative Example 2, which reveals that by coating the cathode active material with maleimide and inorganic conductive material, the batteries can have better stability at a high voltage of 4.6 V.

TABLE 2
Specific Capacity and Capacity Retention at the 100^{th} cycle

| | Example | Example | Example | Example | Example | Comparative | Comparative |
|---|---|---|---|---|---|---|---|
| | 12 | 13 | 16 | 17 | 18 | Example 2 | Example 3 |
| Specific | 168.2 | 159.8 | 164.5 | 158.1 | 162.8 | 149.0 | 154.4 |
| Capacity | | | | | | | |
| (mAh/g) | | | | | | | |
| Capacity | 89 | 85 | 88 | 85 | 88 | 81 | 83 |
| Retention (%) | | | | | | | |

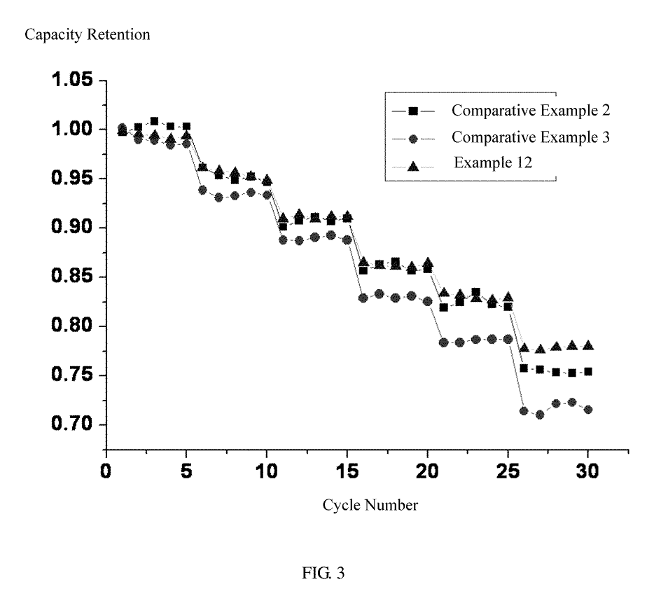

Referring to FIG. 3, the batteries in Examples 12 and Comparative Examples 2, 3 are charged and discharged at constant current rates (C-rate) of 0.2C, 0.5C, 1C, 2C, 3C, and 5C, each for 5 cycles, in a voltage range from 2.8V to 4.3V. It can be observed that Comparative Example 3 has a poorer performance than Comparative Example 2 because the coating layer affected the electron conduction. The inorganic-organic composite coating layer of Example 12 has an improvement on the electron conduction because of the addition of acetylene black, so that the rating performance is substantially the same as that of Comparative Example 2.

In the present disclosure, the organic phase, maleimide monomers or low molecular weight maleimide polymers are mixed with the inorganic phase, inorganic electrical conductive carbonaceous materials. The cathode active material and the mixture are heated in a protective gas at a temperature of 200° C. to 280° C. to produce an inorganic-organic composite material on the surface of the cathode active material so that the organic phase is formed into the high-molecular weight crosslinked polymer. Experiments show that the crosslinked polymer can still have lithium ions in and out the cathode active material, and does not block the diffusion of lithium ions. The crosslinked polymer does not interfere the cycling of the battery. Thus, in the present disclosure, the mechanism for improving the safety is not to block the diffusion of lithium ions, but blocking the interface reaction between the cathode active material and the organic solvent at a higher voltage by the crosslinked polymer. The heat generated by the interface reactions can lead to more interface reactions and produce more heat, which leads to the accumulation of heat inside the battery. The crosslinked polymer can reduce or prevent the occurrence of the interface reaction from the beginning, thereby avoiding thermal runaway due to heat build-up. In addition, since the inorganic electrical conductive carbonaceous material is incorporated into the crosslinked polymer, the electron conductivity of the coating layer can be effectively improved, thereby improving the rating performance of the lithium ion battery.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for making a cathode composite material comprising:
providing a maleimide-based material selected from the group consisting of a maleimide monomer, a maleimide polymer formed from the maleimide monomer, and combinations thereof;
mixing the maleimide-based material, an inorganic electrical conductive carbonaceous material, and a cathode active material to form a mixture; and
heating the mixture to a temperature of about 200° C. to about 280° C. in a protective gas.

2. The method of claim 1, wherein the inorganic electrical conductive carbonaceous material is selected from the group consisting of acetylene black, carbon black, carbon nanotubes, graphene, and combinations thereof.

3. The method of claim 1, wherein the maleimide monomer is selected from the group consisting of a monomaleimide monomer, a bismaleimide monomer, a polymaleimide monomer, a maleimide derivative monomer, and combinations thereof.

4. The method of claim 3, wherein the monomaleimide monomer is represented by a general formula I, and the bismaleimide monomer is represented by formulas II or III:

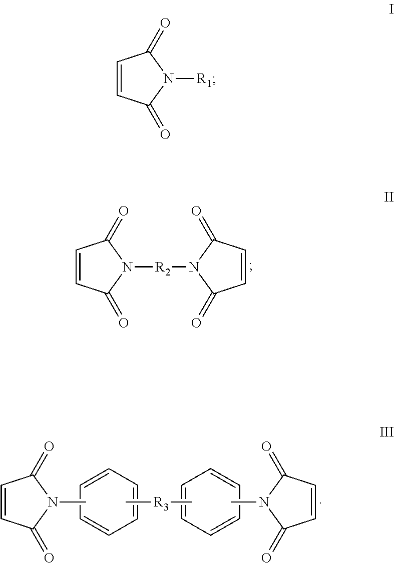

5. The method of claim 4, wherein
R₁ is —R, —RNH₂R, —C(O)CH₃, —CH₂OCH₃, —CH₂S(O)CH₃, a monovalent alicyclic group, a monovalent substituted aromatic group, or a monovalent unsubstituted aromatic group;
R₂ is —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —R—Si(CH₃)₂—O—Si(CH₃)₂—R—, a bivalent alicyclic group, a bivalent substituted aromatic group, or a bivalent unsubstituted aromatic group;
R₃ is —CH₂—, —C(O)—, —C(CH₃)₂—, —O—, —O—O—, —S—, —S—S—, —S(O)—, or —(O)S(O)—; and
R is a hydrocarbyl with 1 to 6 carbon atoms.

6. The method of claim 1, wherein the maleimide monomer is selected from the group consisting of N-phenyl-maleimide, N-(p-tolyl)-maleimide, N-(m-tolyl)-maleimide, N-(o-tolyl)-maleimide, N-cyclohexyl-maleimide, monomaleimide, maleimidephenol, maleimidebenzocyclobutene, dimethylphenyl-maleimide, N-methyl-maleimide, ethenyl-maleimide, thio-maleimide, ketone-maleimide, methylene-maleimide, maleimide-methyl-ether, maleimide-ethanediol, 4-maleimide-phenyl sulfone, and combinations thereof; and
the bismaleimide monomer selected from the group consisting of N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-thiodimaleimide, N,N′-dithiodimaleimide, N,N′-ketonedimaleimide, N,N′-methylene-bismaleimide, bismaleimidomethyl-ether, 1,2-bismaleimido-1,2-ethandiol, N,N′-4,4′-diphenyl-ether-bismaleimide, 4,4′-bismaleimido-diphenylsulfone, and combinations thereof.

7. The method of claim 1, wherein the maleimide polymer is a low-molecular weight polymer having an average molecular weight in a range from about 200 to about 2999.

8. The method of claim 1, wherein the maleimide polymer is formed by dissolving and mixing a barbituric acid compound and the maleimide monomer in an organic solvent to form a solution; and heating and stirring the solution at a temperature of about 100° C. to about 150° C. to form the maleimide polymer.

9. The method of claim 1, wherein a mass ratio of the inorganic electrical conductive carbonaceous material to the maleimide-based material is in a range from about 1:10 to about 1:1.

10. The method of claim 1, wherein a ratio of a total mass of the inorganic electrical conductive carbonaceous material and the maleimide-based material to a mass of the cathode active material is in a range from about 1:9999 to about 5:95.

11. The method of claim 1, wherein the heating the mixture to a temperature of about 200° C. to about 280° C. in a protective gas forms a high-molecular weight crosslinked polymer, and an average molecular weight of the high-molecular weight crosslinked polymer is in a range from about 5000 to about 50000.

12. A cathode composite material comprising a cathode active material and an inorganic-organic composite material composited with the cathode active material, wherein the inorganic-organic composite material comprises an inorganic electrical conductive carbonaceous material and a crosslinked polymer, and the crosslinked polymer is formed by heating a maleimide-based material to a temperature of about 200° C. to about 280° C. in the protective gas.

13. The cathode composite material of claim 12, wherein the maleimide-based material is selected from the group consisting of a maleimide monomer, a maleimide polymer formed from the maleimide monomer, and combinations thereof.

14. The cathode composite material of claim 12, wherein a mass percentage of the inorganic-organic composite material in the cathode composite material is in a range from about 0.01% to about 10%.

15. The cathode composite material of claim 12, wherein the inorganic electrical conductive carbonaceous material is selected from the group consisting of acetylene black, carbon black, carbon nanotubes, graphene, and combinations thereof.

16. The cathode composite material of claim 13, wherein the maleimide monomer is selected from the group consisting of a monomaleimide monomer, a bismaleimide monomer, a polymaleimide monomer, a maleimide derivative monomer, and combinations thereof.

17. The cathode composite material of claim 16, wherein the monomaleimide monomer is represented by a general formula I, and the bismaleimide monomer is represented by formulas II or III:

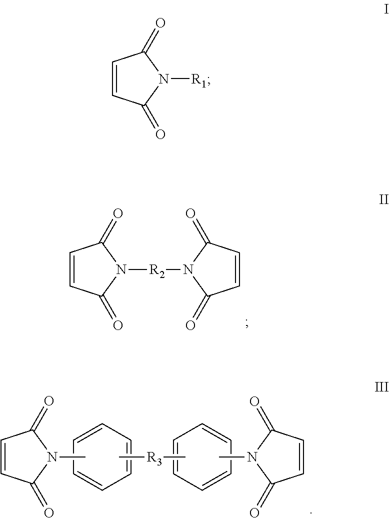

18. The cathode composite material of claim 17, wherein
R₁ is —R, —RNH₂R, —C(O)CH₃, —CH₂OCH₃, —CH₂S(O)CH₃, a monovalent alicyclic group, a monovalent substituted aromatic group, or a monovalent unsubstituted aromatic group;
R₂ is —R—, —RNH₂R—, —C(O)CH₂—, —CH₂OCH₂—, —C(O)—, —O—, —O—O—, —S—, —S—S—, —S(O)—, —CH₂S(O)CH₂—, —(O)S(O)—, —R—Si(CH₃)₂—O—Si(CH₃)₂—R—, a bivalent alicyclic group, a bivalent substituted aromatic group, or a bivalent unsubstituted aromatic group;
R₃ is —CH₂—, —C(O)—, —C(CH₃)₂—, —O—, —O—O—, —S—, —S—S—, —S(O)—, or —(O)S(O)—; and
R is a hydrocarbyl with 1 to 6 carbon atoms.

19. The cathode composite material of claim 12, wherein an average molecular weight of the crosslinked polymer is in a range from about 5000 to about 50000.

20. A lithium ion battery comprising:
a cathode comprising a cathode composite material;
a separator;
an anode separated from the cathode by the separator; and
an electrolyte solution;
wherein the cathode composite material comprises a cathode active material and an inorganic-organic composite material composited with the cathode active material, the inorganic-organic composite material comprises an inorganic electrical conductive carbonaceous material and a crosslinked polymer, and the crosslinked polymer is formed by heating a maleimide-based material to a temperature of about 200° C. to about 280° C. in the protective gas.
